(19) United States
(12) Patent Application Publication
(10) Pub. No.: US 2016/0123796 A1
(43) Pub. Date: May 5, 2016

(54) FREQUENCY-RESPONSE MEASUREMENT DEVICE

(71) Applicant: MITSUBISHI ELECTRIC CORPORATION, Tokyo (JP)

(72) Inventors: Kotaro NAGAOKA, Tokyo (JP); Tomoya FUJITA, Tokyo (JP); Masahiro OZAWA, Tokyo (JP)

(73) Assignee: Mitsubishi Electric Corporation, Tokyo (JP)

(21) Appl. No.: 14/895,008

(22) PCT Filed: Jun. 3, 2013
(86) PCT No.: PCT/JP2013/065380

§ 371 Date: Dec. 1, 2015

(51) Int. Cl. G01H 1/00

(52) U.S. Cl. CPC G01H 1/003

(57) ABSTRACT

A frequency-response measurement device according to an embodiment of the present invention measures a frequency response of a servo system that executes feedback control of a mechanical system. The frequency-response measurement device includes an excitation-condition setting unit that sets a plurality of different excitation conditions, an excitation execution unit that executes the multiple excitations with respect to the servo system by using excitation signals with the different excitation conditions, and a frequency-response calculation unit that acquires a pair of identification input signal and identification output signal for each of the multiple excitations, from a control system of the servo system on which the multiple excitations are performed, and calculates the frequency response based on the excitation conditions for each of the multiple excitations and the pair of identification input signal and identification output signal.

### FIELD

The present invention relates to a frequency-response measurement device that measures a frequency response in a device such as a machine tool.

### BACKGROUND

In machines for industrial applications represented by a machine tool, a frequency response of a mechanical system as a controlled object is measured in order to diagnose the state of the mechanical system and ascertain vibration characteristics thereof. At the time of adjusting a servo system, a frequency response of a control loop such as a speed loop and a position loop is also measured. The frequency response is an amplitude ratio and a phase difference between an input signal and an output signal with respect to the output signal when the input signal of a specific frequency is applied, and is represented by a relation between the frequency and the amplitude ratio (gain) and a relation between the frequency and the phase.

At the time of measuring a frequency response, conventionally, an input signal having a sinusoidal waveform is applied and frequency of the sinusoidal waveform is sequentially changed, by which a gain and a phase for the frequency is measured. However, in such a method of measuring an output signal by gradually changing the frequency of the input signal, there is a problem in that a significant time is required for measuring the frequency response.

Therefore, for example, Patent Literature 1 discloses that white noise is sampled as an input signal, speed obtained when the white noise is applied as a speed command is sampled as output data, and Fourier transform is performed with respect to an acquired speed command and speed data, thereby acquiring frequency response characteristics from the speed command to the speed. Ideal white noise is a signal including all frequency components. Therefore, the frequency response in all frequency domains can be measured in a short measurement time. As practical white noise, a pseudorandom signal referred to as “M-sequence signal” or the like is used.

### CITATION LIST

### Patent Literature

Patent Literature 1: Japanese Patent Application Laid-open No. 2000-278990

### SUMMARY

### Technical Problem

In Patent Literature 1, a response waveform of a mechanical system (for example, speed feedback data) when the mechanical system is excited by applying white noise is measured. However, in a case that a disturbance factor such as friction is present in the mechanical system, there is a problem in that the mechanical system is not sufficiently excited even if white noise is applied, and thus a frequency response cannot be obtained correctly. Particularly, responsiveness in a low frequency domain may be deteriorated due to friction of the mechanical system, and a frequency response in the low frequency domain cannot be obtained correctly.

Specifically, in a case that a frequency response of from torque to speed feedback is measured and that the mechanical system can be approximated by a rigid body system, it is assumed that a frequency response in a low frequency domain is a linear having slope of −20 dB/dec in a gain diagram, and constant at approximately −90° in a phase diagram. On the other hand, in a case that the low frequency domain is not sufficiently excited due to the influence of friction, it is regarded that an output does not sufficiently respond to an input. Therefore, in that domain, the gain may be smaller than an originally supposed value, and the phase may have a value close to 0°.

If a frequency-response measurement result cannot be obtained correctly, for example, a large estimate error occurs when a gain value in a low frequency domain is read to estimate inertia of a mechanical system, or a wrong value is estimated when a peak in a gain diagram or change in a phase diagram is read to estimate a resonance frequency or an attenuation ratio of the mechanical system. Further, in a case that a frequency response is measured for adjustment of a control system and a smaller value than an originally supposed value is measured as a gain in a low frequency domain, a band frequency of the control system cannot be obtained correctly, leading to a problem that gain tuning of the control system cannot be appropriately adjusted.

The present invention has been achieved in view of the above problems, and an object of the present invention is to provide a frequency-response measurement device that can measure a frequency response of a controlled object or a control system accurately in a short time, in a servo system that executes feedback control of a mechanical system subjected to disturbance such as friction.

### Solution to Problem

In order to solve the above problems and achieve the object, there is provided a frequency-response measurement device that measures a frequency response of a servo system that executes feedback control of a mechanical system, the frequency-response measurement device including: an excitation-condition setting unit that sets a plurality of different excitation conditions; an excitation execution unit that executes multiple excitations with respect to the servo system by using excitation signals with the different excitation conditions; and a frequency-response calculation unit that acquires a pair of identification input signal and identification output signal for each of the multiple excitations, from a control system of the servo system on which the multiple excitations has been performed, and calculates the frequency response based on the excitation condition for each of the multiple excitations and the pair of identification input signal and identification output signal.

### Advantageous Effects of Invention

According to the frequency-response measurement device of the present invention, a frequency response is calculated by using excitation data obtained when excitations are performed with a plurality of excitation amplitudes, and thus an accurate frequency response can be measured even if there is disturbance such as friction.

### BRIEF DESCRIPTION OF DRAWINGS

FIG. 1 is a block diagram illustrating a configuration of a frequency-response measurement device according to an embodiment of the present invention.

FIG. 2 is a block diagram illustrating a configuration of a servo system according to the embodiment of the present invention.

FIG. 3 is a diagram illustrating a configuration of a mechanical system according to the embodiment of the present invention.

FIG. 4 is a flowchart for describing a frequency response measurement operation according to the embodiment of the present invention.

FIG. 5-1 is a gain diagram according to a first embodiment of the present invention.

FIG. 5-2 is a phase diagram according to the first embodiment of the present invention.

FIG. 6-1 is a gain diagram according to a second embodiment of the present invention.

FIG. 6-2 is a phase diagram according to the second embodiment of the present invention.

### DESCRIPTION OF EMBODIMENTS

Exemplary embodiments of a frequency-response measurement device according to the present invention will now be explained below in detail with reference to the accompanying drawings. The present invention is not limited to the embodiments.

### First Embodiment

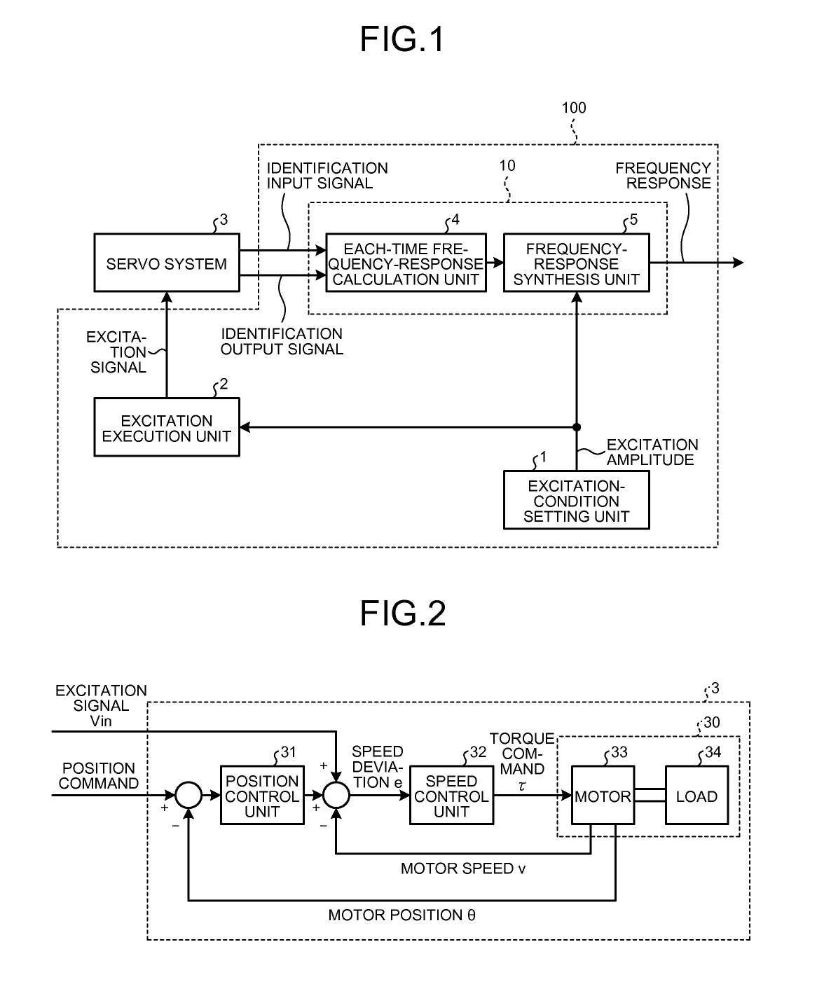

FIG. 1 is a block diagram illustrating a configuration of a frequency-response measurement device 100 according to a first embodiment of the present invention. The frequency-response measurement device 100 includes an excitation-condition setting unit 1, an excitation execution unit 2, and a frequency-response calculation unit 10. The frequency-response calculation unit 10 includes an each-time frequency-response calculation unit 4 and a frequency-response synthesis unit 5. The frequency-response measurement device 100 measures a frequency response of a servo system 3.

The excitation-condition setting unit 1 sets an amplitude of an excitation signal for the excitation execution unit 2, and the excitation execution unit 2 outputs an excitation signal having the set excitation amplitude. The excitation signal output from the excitation execution unit 2 is input to the servo system 3, and excitation is executed in the servo system 3 whose configuration will be described later. An identification input signal and an identification output signal in the servo system 3 at the time of excitation are transmitted to the frequency-response calculation unit 10, in which a frequency response between the identification input signal and the identification output signal is calculated, and a final frequency response is obtained based on the calculated frequency response and output therefrom.

In the frequency-response calculation unit 10, each of the identification input signals and each of the identification output signals are input from the servo system 3 for each of excitations that are performed multiple times. The each-time frequency-response calculation unit 4 calculates each of frequency responses based on each of the identification input signals and each of the identification output signals. Each of the frequency responses is input to the frequency-response synthesis unit 5. The frequency-response synthesis unit 5 performs calculation for synthesizing frequency responses from each of the frequency responses, based on each of the excitation amplitudes input from the excitation-condition setting unit 1, and outputs the obtained frequency response.

FIG. 2 is a block diagram illustrating a configuration of the servo system 3 according to the embodiment of the present invention. The servo system 3 includes a position control unit 31, a speed control unit 32, a motor 33, and a load 34. The load 34 is connected to the motor 33 and the motor 33 and the load 34 constitute a mechanical system 30. The servo system 3 is configured by a servo-system position control loop and a speed control loop.

A deviation between a position command and a motor position θ is input to the position control unit 31, and a speed deviation e is calculated by subtracting a motor speed v from a speed command which is a sum of an output of the position control unit 31 and the excitation signal Vin. The speed deviation e is input to the speed control unit 32, and the speed control unit 32 calculates a torque command τ. In accordance with the torque command τ, the motor 33 is drive controlled. In practice, a torque control unit and a power conversion unit are provided in the speed control loop, the description of which are omitted in FIG. 2 because the response thereof is very fast and response delay can be ignored. Proportional control is used for the position control executed by the position control unit 31, and proportional-integral control is used for the speed control executed by the speed control unit 32.

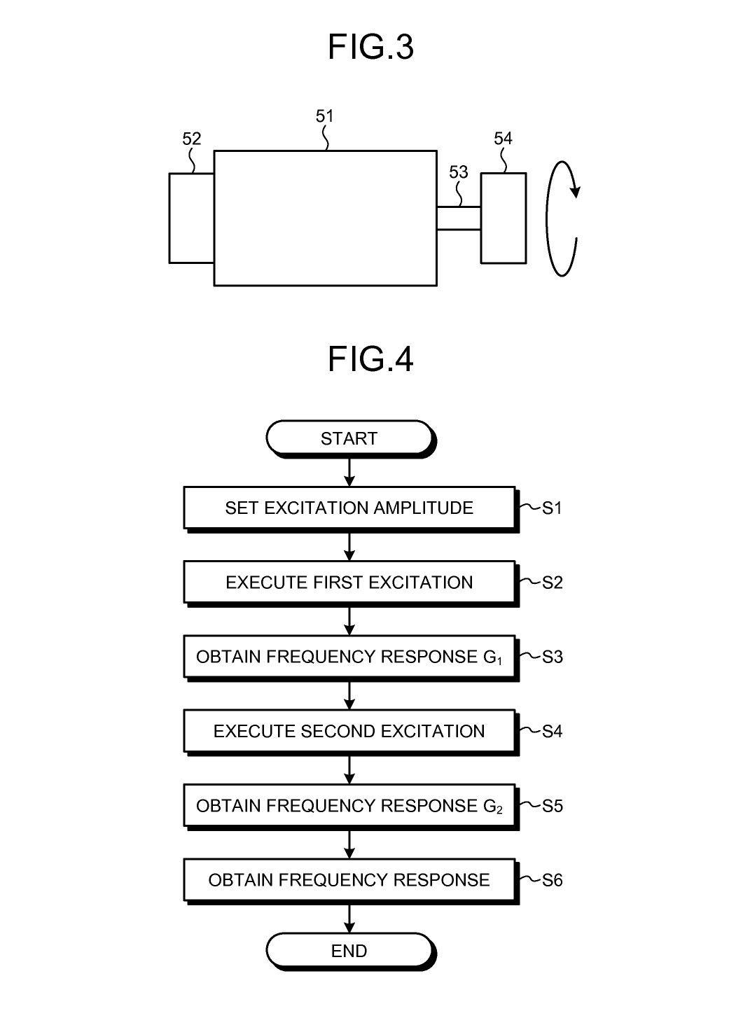

FIG. 3 is a diagram illustrating a configuration of the mechanical system 30 according to the present embodiment. A load inertia 54 is coupled via a shaft 53 with a servo motor 51 that generates rotation torque in response to the reception of the torque command τ. A rotary encoder 52, which is a position detector, is also attached to the servo motor 51, so that the position (a rotation angle) of the servo motor 51 is detected and output. The motor speed v can be obtained by calculating of the derivative of this position.

Operations of the frequency-response measurement according to the present embodiment is described with reference to a flowchart in FIG. 4. First, the excitation-condition setting unit 1 sets two types of excitation amplitude A₁ and A₂ (Step S1 in FIG. 4). The excitation execution unit 2 generates a first excitation signal Vin1 whose amplitude is A₁, and a second excitation signal Vin2 whose amplitude is A₂. In the present embodiment, the excitation amplitude is defined as half amplitude, that is, a width from 0 to a positive or negative maximum value. Each of the excitation signals is an M-sequence signal (a pseudorandom signal), and a binary signal having predetermined points of −1 and 1 is generated in accordance with a generation algorithm of the M-sequence signal. The first excitation signal Vin1 is set to have a value obtained by multiplying the binary signal by the excitation amplitude A₁, and the second excitation signal Vin2 is set to have a value obtained by multiplying the binary signal by the excitation amplitude A₂. A method for generating the M-sequence signal is well known in the signal processing field, and thus descriptions thereof are omitted.

The first excitation signal Vin1 is applied to the speed command, and a first excitation by the excitation execution unit 2 is performed for the servo system 3 (Step S2). At the time of the excitation performed, it is assumed that the position command is set to have a constant value at all times. That is, the excitation of the mechanical system 30 is performed by using the excitation signal Vin1 applied to the speed command. A torque command signal τ₁ at that time is acquired as a first identification input signal, and a motor speed signal v₁ at that time is acquired as a first identification output signal.

Subsequently, a frequency response of from the torque command τ to the motor speed v is calculated by the each-time frequency-response calculation unit 4 based on the first identification input signal and the first identification output signal (Step S3). As the method of obtaining the frequency response between input and output based on the identification input signal and the identification output signal, a known method such as a periodogram method, ARX model identification, or a subspace method may be used. Details of these methods are described in, for example, “System identification for control by MATLAB” (Tokyo Denki University Press) or the like, and thus descriptions thereof are omitted here. The frequency response acquired by the first excitation is designated as G₁(jω). ω denotes a frequency, an absolute value of G₁(jω) is a gain, and an argument in a complex domain of G₁(jω) is a phase.

Second excitation by the second excitation signal Vin2 is performed in the same manner as the first excitation (Step S4). The frequency response acquired by the second excitation is designated as G₂(jω) (Step S5).

A calculation procedure of the frequency response in the frequency-response synthesis unit 5 is described next. Of the torque commands τ, torque ascribed to disturbance such as friction is designated as τf, and it is assumed that this torque is substantially the same in the first excitation and the second excitation. Subsequently, the torque command output by the speed control unit 32 at the time of first excitation is designated as τ₁, and the torque command output by the speed control unit 32 at the time of second excitation is designated as τ₂. Each of torque commands is a sum of the torque τ₁ ascribed to the disturbance and the torque command output by the speed control unit 32. Since each of the frequency responses is a ratio between each of the torque commands and the motor speed, the following expression (1) and expression (2) are established. That is, it is considered that the following expression (1) and expression (2) are established for G₁ and G₂ respectively actually acquired at Step S3 and Step S5 described above.

$$\begin{matrix}[ Expression 1 ] & \\ {G}_{1} = \frac{{v}_{1}}{{τ}_{1} + {τ}_{f}} & ( 1 ) \\ [ Expression 2 ] & \\ {G}_{2} = \frac{{v}_{2}}{{τ}_{2} + {τ}_{f}} & ( 2 )\end{matrix}$$

If it is assumed that the band frequency of the speed control is sufficiently high, the ratio between the first motor speed v₁ and the second motor speed v₂ substantially matches the ratio between the first excitation signal Vin1 and the second excitation signal Vin2. Further, the torque command τ₁ output by the first speed control and the torque command τ₂ output by the second speed control substantially match the ratio between the first excitation signal Vin1 and the second excitation signal Vin2. If these are represented by expressions, the following expression (3) and expression (4) are established.

[Expression 3]

v₁=A₁v,τ=A₁τ (3)

[Expression 4]

v₂=A₂v,τ₂=A₂τ (4)

Here, v denotes a reference motor speed, and τ denotes a reference torque command. If the expression (3) and the expression (4) are substituted into the expression (1) and the expression (2) and τ_{f} is eliminated, the following expression (5) is acquired as a relation between the torque command τ as the reference and the motor speed v as the reference. By using the expression (5) and also using the frequency responses acquired through two rounds of actual measurement, an accurate frequency response in which a component ascribed to disturbance such as friction has been removed can be calculated.

$$\begin{matrix}[ Expression 5 ] & \\ \frac{v}{τ} = \frac{{A}_{1} - {A}_{2}}{\frac{{A}_{1}}{{G}_{1 }} - \frac{{A}_{2}}{{G}_{2 }}} & ( 5 )\end{matrix}$$

The frequency-response synthesis unit 5 outputs a frequency response function acquired by calculation of the expression (5) as a frequency response of an open loop of from the torque command to the motor speed. That is, a value for each frequency is obtained from the fractions having a denominator and a numerator, the denominator being obtained by subtracting the ratio between the second excitation amplitude A₂ and a second frequency response G₂ from the ratio between the first excitation amplitude A₁ and a first frequency response G₁, and the numerator being a difference between the first excitation amplitude A₁ and the second excitation amplitude A₂. The frequency-response synthesis unit 5 outputs the resultant values as the frequency response (Step S6).

The effect of the first embodiment is described with reference to FIG. 5-1 and FIG. 5-2. The frequency responses were obtained based on the calculation of the expression (5), by sampling the torque command signal τ and the motor speed signal v at the time of exciting the servo motor by changing the excitation amplitude according to the method described above. The excitation amplitude is represented as a ratio to an excitation amplitude as having 100% when the torque amplitude at the time of excitation matches a rated torque. The first excitation amplitude A₁ was set to 5%, and the second excitation amplitude A₂ was set to 8%. That is, an absolute value of the excitation amplitude A₂ is larger than an absolute value of the excitation amplitude A₁. However, the order of excitations using the excitation signals having such amplitudes may be reversed. If the mechanical system 30 can be approximated by a rigid body, a transfer function of from the torque command τ to the motor speed v is expressed as a multiplication of a first integral and a reciprocal of inertia. That is, a transfer function Gₚ(s) of from the torque command τ to the motor speed v is represented by the following expression (6).

$$\begin{matrix}[ Expression 6 ] & \\ {G}_{p} ( s ) = \frac{1}{Js} & ( 6 )\end{matrix}$$

Here, s denotes a Laplace operator, and J denotes inertia of the mechanical system 30. The mechanical system 30 used in the present embodiment is a single motor, and the characteristics thereof can be regarded as rigid body. Therefore, an ideal response in the mechanical system 30 is designated as Gₚ(jω). If the frequency response calculated by the frequency-response synthesis unit 5 is close to the ideal response, it can be regarded that the frequency response has been obtained correctly. The ideal response has a linear shape whose slope is −20 dB/dec in a gain diagram and has a constant value at −90° in a phase diagram.

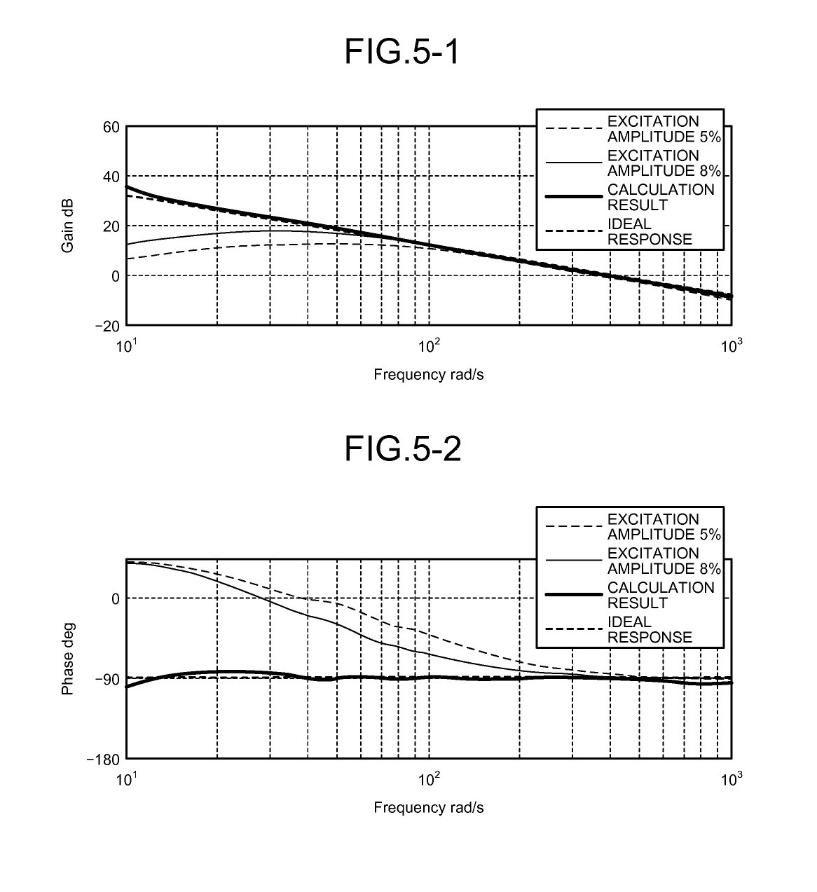

FIG. 5-1 and FIG. 5-2 are Bode diagrams for comparing the first frequency response G₁ (excitation amplitude A₁:5%) acquired based on actual measurement, the second frequency response G₂ (excitation amplitude A₂:8%) acquired also based on actual measurement, a frequency response (a calculation result) obtained by the frequency-response synthesis unit 5 by calculation of the expression (5), and an ideal response Gₚ. FIG. 5-1 is a gain diagram, and FIG. 5-2 is a phase diagram. With regard to the respective curves, a thin broken line represents the first frequency response G₁, a thin solid line represents the second frequency response G₂, a thick solid line represents the calculation result obtained by the frequency-response synthesis unit 5, and a thick broken line represents the ideal response Gₚ.

The first frequency response G₁ and the second frequency response G₂ have a smaller value than the ideal response in the gain diagram in a frequency domain equal to or lower than 100 rad/s as illustrated in FIG. 5-1, and have a value away from −90°, being a value of an ideal curve, in the phase diagram in a frequency domain of equal to or lower than 300 rad/s as illustrated in FIG. 5-2. When the first frequency response G₁ and the second frequency response G₂ are compared, the first frequency response G₁ has a larger deviation. This is because the ratio of the torque τ_{f} ascribed to disturbance to the torque command τ increases as the excitation amplitude decreases, and thus the first frequency response G₁ having smaller excitation amplitude is largely deviated from the ideal curve. On the other hand, the calculation result obtained by the frequency-response synthesis unit 5 represents substantially the same response as the ideal response Gₚ, both in the gain diagram and the phase diagram. This is because of the effect that calculation for removing the influence of disturbance is performed using the first frequency response G₁ and the second frequency response G₂.

As described above, according to the first embodiment, a frequency response is calculated by using excitation data obtained when excitations are performed using a plural types of excitation amplitude, and thus an accurate frequency response can be measured even if there is disturbance such as friction. Further, the frequency response is calculated by using the excitation data obtained when excitations are performed using the changed amplitudes of the excitation signals, and thus an influence of disturbance such as friction on the frequency response measurement result can be eliminated, thereby enabling to measure an accurate frequency response. A frequency response can be accurately obtained also by extracting a fluctuation portion of the frequency response due to disturbance such as friction and performing calculation to correct the influence thereof. In addition, even if there is disturbance such as friction, a frequency response of a mechanical system can be accurately obtained, thereby enabling to perform diagnosis of inertia of the mechanical system, vibration characteristics, and the like correctly.

### Second Embodiment

The configuration of the frequency-response measurement device 100 according to a second embodiment is same as that illustrated in FIG. 1. A block diagram illustrating the configuration of the servo system 3 according to the second embodiment is also same as that illustrated in FIG. 2. The different point of the frequency-response measurement device 100 according to the second embodiment from the frequency-response measurement device 100 according to the first embodiment is that a speed deviation signal e instead of the torque command signal τ is used as the identification input signal. This corresponds to a case that a frequency response of a speed open loop including the speed control unit 32 is measured.

When the frequency response of the speed open loop is measured, an accurate frequency response can be measured according to a method similar to that of the first embodiment. That is, in the present embodiment also, the excitation execution unit 2 generates excitation signals Vin1′ and Vin2′ by using two types of excitation amplitude A₁′ and A₂′ set by the excitation-condition setting unit 1 and applies the excitation signals Vin1′ and Vin2′ to the speed command for the servo system 3.

Accordingly, the each-time frequency-response calculation unit 4 obtains a frequency response G₁′ (jω) at the first excitation based on the speed deviation as the first identification input signal and the motor speed as the first identification output signal. Further, the each-time frequency-response calculation unit 4 obtains a frequency response G₂′ (jω) at the second excitation based on the speed deviation as the second identification input signal and the motor speed as the second identification output signal. The frequency-response synthesis unit 5 can obtain the frequency response of the speed open loop correctly, even in a state having disturbance such as friction, by using the frequency responses G₁′ and G₂′ respectively acquired at the first and second excitations, according to the following expression (7) obtained in the same manner as the expression (5).

$$\begin{matrix}[ Expression 7 ] & \\ \frac{v}{e} = \frac{{A}_{1}^{’} - {A}_{2}^{’}}{\frac{{A}_{1}^{’}}{{G}_{1}^{’}} - \frac{{A}_{2}^{’}}{{G}_{2}^{’}}} & ( 7 )\end{matrix}$$

The effect of the second embodiment is described with reference to FIG. 6-1 and FIG. 6-2. The speed deviation e and the motor speed signal v at the time of exciting the servo motor using the changed excitation amplitudes according to the method described above is sampled, and the frequency response was obtained based on the calculation of the expression (7). The excitation amplitude is represented as a ratio to an excitation amplitude as having 100% when the torque amplitude at the time of excitation matches a rated torque. The first excitation amplitude A₁′ was set to 8%, and the second excitation amplitude A₂′ was set to 10%. That is, an absolute value of the excitation amplitude A₂′ is larger than an absolute value of the excitation amplitude A₁′. However, the order of excitations by excitation signals having such amplitudes can be reversed. A transfer function of from the speed deviation e to the motor speed v is expressed as a multiplication of a transfer function of the mechanical system 30 and a transfer function of the speed control unit 32. If the mechanical system 30 can be approximated by a rigid body, the transfer function of the mechanical system 30 is expressed as a multiplication of a first integral and the reciprocal of inertia. Further, the speed control unit 32 is proportional-integral control of a proportional gain Kᵥₚ and an integral gain Kᵥᵢ. Accordingly, a transfer function Gᵥ(s) of from the speed deviation e to the motor speed v is represented by the following expression (8).

$$\begin{matrix}[ Expression 8 ] & \\ {G}_{v} ( s ) = \frac{1}{Js} {K}_{vp} ( 1 + \frac{{K}_{vi}}{s} ) & ( 8 )\end{matrix}$$

Here, s denotes a Laplace operator, and J denotes inertia of the mechanical system 30. The mechanical system 30 used in the present embodiment is a single motor, and the characteristics thereof can be regarded as a rigid body. Therefore, an ideal response of from the speed deviation e to the motor speed v is designated as Gᵥ(jω), and if the frequency response calculated by the frequency-response synthesis unit 5 is close to the ideal response, it can be regarded that the frequency response has been obtained correctly. The ideal response has a linear shape whose slope is −40 dB/dec in a lower frequency domain in the gain diagram and has a curved shape in the phase diagram such that the phase shifts from −90° to −180° as approaching to lower frequency.

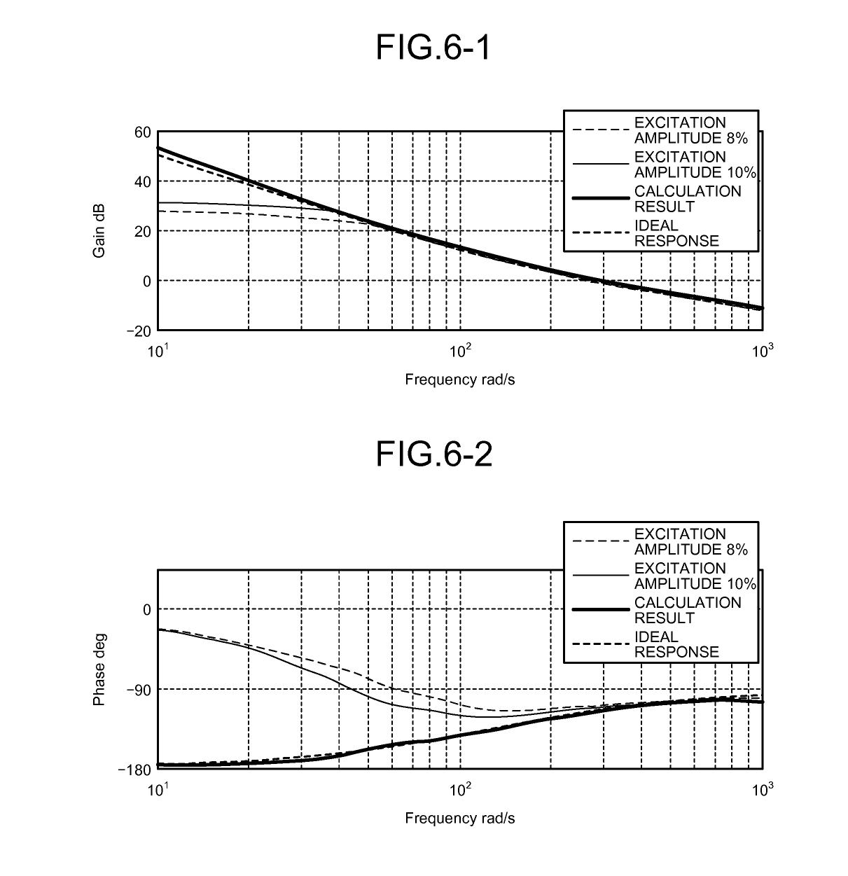

FIG. 6-1 and FIG. 6-2 are Bode diagrams for comparing the first frequency response G₁′ (excitation amplitude Aₗ′:8%) acquired based on actual measurement, the second frequency response G₂′ (excitation amplitude A₂′:10%) acquired based on actual measurement, a frequency response (a calculation result) obtained by the frequency-response synthesis unit 5 by calculation of the expression (7), and an ideal response Gᵥ. FIG. 6-1 is a gain diagram, and FIG. 6-2 is a phase diagram. With regard to the respective curves, a thin broken line represents the first frequency response G₁′, a thin solid line represents the second frequency response G₂′, a thick solid line represents the calculation result obtained by the frequency-response synthesis unit 5, and a thick broken line represents the ideal response Gᵥ.

The first frequency response G₁′ and the second frequency response G₂′ have a smaller value than the ideal response in the gain diagram in a frequency domain equal to or lower than 50 rad/s as illustrated in FIG. 6-1, and have a value away from a value of an ideal curve in the phase diagram in a frequency domain equal to or lower than 200 rad/s as illustrated in FIG. 6-2. When the first frequency response G₁′ and the second frequency response G₂′ are compared, the first frequency response G₁′ has a larger deviation. This is because the ratio of the torque τ_{f} ascribed to disturbance to the torque command τ increases as the excitation amplitude decreases, and thus the first frequency response G₁′ having smaller excitation amplitude is largely deviated from the ideal curve. On the other hand, the calculation result obtained by the frequency-response synthesis unit 5 represents substantially the same response as the ideal response Gᵥ, both in the gain diagram and the phase diagram. This is because of the effect that calculation for removing the influence of disturbance is performed using the first frequency response G₁′ and the second frequency response G₂′.

As described above, according to the second embodiment, by calculating a frequency response by using excitation data obtained when excitations are performed using a plural types of excitation amplitude, an accurate frequency response can be measured even if there is disturbance such as friction. Further, by calculating the frequency response by using the excitation data obtained when excitations are performed using the changed amplitudes of the excitation signals, an influence of disturbance such as friction on the frequency response measurement result can be eliminated, thereby enabling to measure an accurate frequency response. A frequency response can be accurately obtained also by extracting a fluctuation portion of the frequency response due to disturbance such as friction and performing calculation to correct the influence thereof. In addition, even if there is disturbance such as friction, a frequency response of a speed open loop including the speed control unit can be accurately obtained, thereby enabling to adequately perform gain adjustment of a servo system and adjustment of a vibration suppression filter.

In the embodiments described above, the torque τf ascribed to disturbance such as friction, which is assumed to be substantially the same in the first excitation and the second excitation, is designated as one unknown parameter as represented in the expression (1) and the expression (2). Therefore, the two relational expressions acquired through two rounds of measurement are sufficient to remove the component ascribed to disturbance. Accordingly, if it is assumed that the number of unknown parameters ascribed to disturbance is increased to n, it is considered in principle that a frequency response from which disturbance elements are removed can be acquired if n+1 rounds of measurement are executed while changing the conditions.

Furthermore, the invention of the present application is not limited to the above embodiments, and when the present invention is carried out, the invention can be variously modified without departing from the scope thereof. Inventions of various stages are included in the above embodiments, and various inventions can be extracted by appropriately combining a plurality of constituent elements disclosed herein. For example, even when some constituent elements are omitted from all constituent elements described in the embodiments, as far as the problems mentioned in the section of Solution to Problem can be solved and effects mentioned in the section of Advantageous Effects of Invention are obtained, the configuration from which these constituent elements are omitted can be extracted as an invention. In addition, constituent elements described in different embodiments can be appropriately combined.

### INDUSTRIAL APPLICABILITY

As described above, the frequency-response measurement device according to the present invention is useful for measuring a frequency response of a control loop such as a speed loop and a position loop at the time of adjustment of a servo system, and in particular suitable for measuring of an accurate frequency response even if there is disturbance such as friction.

### REFERENCE SIGNS LIST

1 excitation-condition setting unit, 2 excitation execution unit, 3 servo system, 4 each-time frequency-response calculation unit, 5 frequency-response synthesis unit, 10 frequency-response calculation unit, 30 mechanical system, 31 position control unit, 32 speed control unit, 33 motor, 34 load, 51 servo motor, 52 rotary encoder, 53 shaft, 54 load inertia, 100 frequency-response measurement device, S1 to S6 step.

1. A frequency-response measurement device that measures a frequency response of a servo system that executes feedback control of a mechanical system, the frequency-response measurement device comprising:
an excitation-condition setting unit to set a plurality of different excitation conditions;
an excitation execution unit to execute multiple excitations with respect to the servo system by using excitation signals with the different excitation conditions; and
a frequency-response calculation unit to acquire a pair of identification input signal and identification output signal for each of the multiple excitations, from a control system of the servo system on which the multiple excitations has been performed, and to calculate the frequency response based on the excitation condition for each of the multiple excitations and the pair of identification input signal and identification output signal, wherein
the excitation condition is excitation amplitude which is amplitude of the excitation signal, and wherein
the frequency-response calculation unit includes
an each-time frequency-response calculation unit to calculate a frequency response for each of the multiple excitations, based on the pair of identification input signal and identification output signal for each of the multiple excitations, and
a frequency-response synthesis unit to calculate the frequency response based on the frequency response for each of the multiple excitations and the excitation condition.

2-3. (canceled)

4. The frequency-response measurement device according to claim 1, wherein
the excitation-condition setting unit sets first excitation amplitude and second excitation amplitude different from the first excitation amplitude as the excitation amplitude, and
the frequency-response synthesis unit calculates, as the frequency response, a value of a fractional expression having a denominator and a numerator, wherein
the denominator is a difference between a ratio of the first excitation amplitude to the frequency response for each of the multiple excitations at the first excitation amplitude and a ratio of the second excitation amplitude to the frequency response for each of the multiple excitations at the first excitation amplitude, and
the numerator is a difference between the first excitation amplitude and the second excitation amplitude.

5. The frequency-response measurement device according to claim 1, wherein the excitation signal is applied to a speed command of the control system, and a position command applied to the control system has a constant value under the different excitation conditions.

6. The frequency-response measurement device according to claim 1, wherein the pair of identification input signal and identification output signal constitutes an open loop in the control system.

7. The frequency-response measurement device according to claim 6, wherein the identification input signal is a torque command signal of the servo system and the identification output signal is a speed signal of the servo system.

8. The frequency-response measurement device according to claim 6, wherein the identification input signal is a speed deviation signal of the servo system and the identification output signal is a speed signal of the servo system.
